(19) United States
(12) Patent Application Publication
(10) Pub. No.: US 2025/0006201 A1
(43) Pub. Date: Jan. 2, 2025

(54) Device, System, and Method for Automatically Generating Organization-Wide Insights from Multiple Automatically-Generated Meeting Transcripts

(71) Applicant: AudioCodes Ltd., Lod (IL)

(72) Inventors: Shabtai Adlersberg, Ra'anana (IL); Tatiana Adar, Belle Mead, NJ (US); Menachem Honig, Meitar (IL); Shay Harel, Bat Hen (IL); Mony Bulocinic, Petah Tikva (IL); Guy Shlomo Yaffe, Rishon LeZion (IL)

(21) Appl. No.: 18/215,213

(22) Filed: Jun. 28, 2023

(51) Int. Cl. G10L 17/14; G06T 11/20; G10L 17/22

(52) U.S. Cl. CPC G10L 17/14; G06T 11/206; G10L 17/22; G06Q 10/1095

(57) ABSTRACT

Device, system, and method for automatically generating organization-wide insights from multiple automatically-generated meeting transcripts. A method includes: (a) automatically obtaining or generating a plurality of organizational meeting transcripts, that correspond to a plurality of organizational meetings that took place within a particular time-period by participants that are associated with a particular organization; (b) automatically providing the plurality of organizational meeting transcripts as inputs to a Large Language Model (LLM) engine; (c) automatically providing to the LLM engine an LLM prompt, commanding the LLM engine to generate insights that the LLM engine can derive by performing LLM analysis of said plurality of organizational meeting transcripts; and (d) automatically generating, by the LLM engine, based on said prompt and based on said plurality of textual transcripts, one or more LLM-generated insights.

### FIELD

Some embodiments are related to the field of computerized systems and electronic systems.

### BACKGROUND

Millions of people utilize mobile and non-mobile electronic devices, such as smartphones, tablets, laptop computers and desktop computers, in order to perform various activities. Such activities may include, for example, browsing the Internet, sending and receiving electronic mail (email) messages, taking photographs and videos, engaging in a video conference or a chat session, playing games, or the like.

### SUMMARY

Some embodiments include systems, devices, and methods for automatically generating organization-wide insights (e.g., business insights) from multiple automatically-generated meeting transcripts that correspond to meetings held by organization team-members during a defined time-period (e.g., last week, last month).

Some embodiments may provide other and/or additional benefits and/or advantages.

### BRIEF DESCRIPTION OF THE DRAWINGS

FIG. 1 is a schematic block-diagram illustration of a system, in accordance with some demonstrative embodiments of the present invention.

### DETAILED DESCRIPTION OF SOME DEMONSTRATIVE EMBODIMENTS

The Applicant has realized that some large corporations, organizations or enterprises have thousands or tens-of-thousands of employees and/or other team-members (consultants, contractors); who may participate in hundreds or even thousands of meetings every day. The Applicant has further realized that many of these meetings are held via technological infrastructure of video conference, such as using Microsoft Teams or Zoom or Google Meet platforms; such that some or all participants in such meeting, or at least one participant in such meeting, participate via an electronic device (e.g., laptop computer, desktop computer, smartphone, tablet). The Applicant has also realized that many of such meetings are recorded or can be recorded, such that their video and/or their audio are captured and stored for later retrieval or playback; optionally subject to implied consent or explicit consent from one or more of the participants in such meeting.

The Applicant has realized that unfortunately, a manager or a managerial team of a large organization, lacks an efficient tool for extracting useful and actionably insights or determinations or conclusions from such large corpus of meetings.

The Applicant has realized that there is a need for an automated tool or system that can autonomously obtain or generate textual transcripts of the hundreds—or ever thousands—of organizational meetings that are held per day; and that can analyze such hundreds or thousands of textual transcript from a large plurality of such meetings, and extract from them organization-wide or collective insights; and particularly, an aggregated or a collective insight that cannot be extracted from a single transcript of a single meeting, but that can be extract or learned only from analysis of dozens or hundreds or thousands of meeting transcripts.

Some embodiments thus provide an automated system that automatically generates or obtains transcripts of meetings of a particular organization; and prepare a batch of transcripts in an automatic manner, such as a daily batch that includes all the transcripts of all the meetings held on a particular day, or a weekly batch that includes all the transcripts of all the meetings held on a particular week, or similarly a bi-weekly or monthly or quarterly or annual batch includes all the transcripts of all the meetings held in such corresponding time-period. The batch of transcripts are automatically fed as input into an Artificial Intelligence (AI) engine/Machine Learning (ML) engine/Deep Learning (DL) engine/Reinforcement Learning (RL)/Neural Network (NN) engine, and particularly to a Large Language Model (LLM) engine; and particularly an LLM engine (such as ChatGPT of OpenAI, or LLAMA of Meta, or Bard of Google/Alphabet) which can be pre-trained on a large training corpus of business or business-related or business-oriented meeting transcripts, optionally in a particular field (e.g., finance; legal; marketing). Such LLM engine can be prompted or inquired to configured to autonomously analyze such large plurality of organizational meeting transcripts, and to autonomously generate from them insights.

In accordance with some embodiments, a user of such system (e.g., a manager or CEO of a large organization), does not need to explicitly prompt the system, manually or otherwise, with a prompt such as “Please review the transcripts of 5,000 meetings that were held in the organization this week, and show me all the transcript-portions that relate to Client Adam”; but rather, the system is already configured to search by itself and to autonomously generates insights that a human cannot necessarily predict or estimate in advance that they exist or that they are meaningful or important or relevant. For example, the system may be automatically prompted to “generate a description of a surprising Trend related to Marketing that you, the LLM engine, can extract from the 5,000 meeting transcripts of last week”; or the system may be automatically prompted to “generate a description of the Topic/the Client/the Customer/the Supplier/the Product/the Service/the Problem, that was most frequently discussed in all 4,000 meeting transcript of the organization last week”; or the system may be automatically prompted to “generate a description of the topic or problem or trend, that you—the LLM engine—determine to be of the highest level of business importance, from the 6,000 organizational meetings that were held yesterday”; or the system may be automatically prompted to “generate a description of the topic or problem or trend, that you—the LLM engine—determine to be of the highest affect on the organization's Profit/Revenue/Expenses/Legal Situation, from the 7,000 organizational meetings that were held yesterday”.

In some embodiments, the system may be configured by the relevant manager to enable manual filtering or slicing of the information or the insights extraction process; for example, the system may enable a manager in the organization to define that he wants to receive automated organization-wide insights, that the LLM engine can extract by itself from reviewing the 8,000 meeting transcripts of meetings held yesterday in the organization, but only insights related to Budget (or related to Profit, or related to Expenses, or related to Legal, or related to Marketing). In some embodiments, the system may enable the manager to define, that she wants such insights to be autonomously derived only from meeting transcripts that were conducted last week in the European branch(es) of the organization (or other geographical region), or only from meeting transcripts that were conducted yesterday and that at least one person from the Financial Department has attended; or to add other filtering/slicing criteria to fine-tune the LLM-based insights extraction by the LLM engine, but still without necessarily telling the LLM engine explicitly which topic or which client or which project should be the focus of the insights extraction. For example, the manager does not need to tell the automated system, “please generate only Japan-related insights from all the 6,000 transcripts of last week's meetings”; but rather, the system allows the manager to define or to select “only the 2,000 meetings held last week in Japan”, and to request from the LLM engine to perform autonomous extraction of any relevant/surprising/unexpected insights from that slice or subset of all the organizational meetings. In other words, the system does Not require from the manager to prompt the LLM engine to “please generate all the insights about Japan from last week's 5,000 meeting transcripts”, but rather, the system enables the manager to select a geographical region (e.g., only Japan), and then generates all insights or trends that it can autonomously derive from LLM-based analysis of the transcripts of meetings that were held by the organization last week in Japan. Similarly, the system does Not require from the manager to prompt the LLM engine to “please generate all the insights about Marketing from last week's 6,000 meeting transcripts”, but rather, the system enables the manager to select or to define a meeting-filtering criterion, such as “only meetings that occurred last week and that included at least one participant from the Marketing Department”; and then generates all insights or trends that it can autonomously derive from LLM-based analysis of that subset of the meetings transcripts (and such insights can be related to Marketing or can be related to other non-marketing topics).

Some embodiments may further automatically and autonomously construct a Heat Map or a Trends Map, or a Dynamically-Updated Heat Map or Trends Map, or other suitable graphical and/or textual representation, which automatically tracks and dynamically updated trends with regard to the insights/topics/clients/projects that the LLM engine had autonomously identified in its LLM-based analysis of meeting transcript, across time or over time. For example, on January 8, the LLM engine reviews the 5,000 meeting transcripts that the organization held during Week 1 of the year; and extracts a first insight that “Legal Problem in the Japanese Market” has the greatest importance; and generates a second insight that “Sales in France” were of second importance; and generates a third insight that “Personnel in Brazil” was of third importance. The system can thus automatically generate a Heat Map on January 8, indicating Insight 1 with a first shade of Red, and indicating Insight 2 with a first shade of Green, and indicating Insight 3 with a first shade of Blue. Then, a week later, on January 15, the LLM engine reviews the 6,000 meeting transcripts that the organization held during Week 2 of the year; and extracts a first insight that “Legal Problem in the Japanese Market” has reduced its importance, and thus the Heat Map is updated from dark red to light red or pink; and generates a second insight that “Sales in France” has grown in importance as reflected in the meeting transcripts of Week 2, and thus the Heat Map is updated from regular green to dark green; and generates a third insight that “Personnel in Brazil” is now entirely not important or not relevant (as reflected in the organizational meeting transcripts of Week 2), and its Heat Map color is automatically updated from blue to “grayed out” or strike-through. In other embodiments, each insight is represented by a Vertical Bar; which can grow upwardly or shrink downwardly from day to day, or from week to week (or the like), to dynamically reflect the Trend of change in the relevance/importance of that topic/project/client/other insights, as reflected in a fresh batch of meeting transcripts. In other embodiments, each such insights is represented by a Bubble Chart, such that bubbles or circles of different size correspond to the level of importance of each such topic/insight; and those bubbles or circles in the Bubble Chart can dynamically expand or shrink, by dynamic updates from day to day or from week to week, to reflect the changes in their importance/relevance that the LLM engine determines over time from further batches of meeting transcripts. In some embodiments, the Heat Map or the Bubble Chart or the Bars Chart or other representation, may be configured or defined to represent the Top N trending topics/clients/problems/projects across the entire organization in the past D days; such as, the top 10 trending clients across the entire organization in the past 7 days; or, to represent the Top N trending topics/clients/problems/projects across the a particular subset (or slice) of the entire organizational meetings within D days; such as, the top 15 clients/topics/project that are estimated by the LLM engine to be of the greatest importance/relevance to management, as reflected in meeting transcripts from the past 14 days, that had at least one participant from the Legal Department and/or at least one participant from the European branch(es) of the organization. Other criteria or conditions may be configured and applied.

Other suitable types of representations may be generated and may be dynamically updated or modified by the system based on the LLM engine outputs; to thereby provide to the manager a birds-eye view or an “at a glance” view of the important/relevant insights as well as their Trend of Change Over Time.

In some embodiments, the manager may define or configure in advance, that the system would automatically send or deliver to its electronic device (computer, smartphone, tablet), an alert/notification/update, upon derivation or deduction of a new insight from a fresh batch of LLM-based analysis of meeting transcripts, or upon derivation or deduction of a change in a Trend of an already-derived insights or topic; for example, dynamically alerting or notifying the manager (e.g., by text, by SMS, by email, by instant messaging) that a particular topic/client/project is not Trending, or has tripled its relevancy/importance/trending score (e.g., hinting to the manager that this might be a problem that should be addressed or handled by management); or in contrast, that a particular other topic/client/project is not trending any more, or appears to be less relevant or not relevant any more based on the LLM-analysis of the meeting transcripts (e.g., hinting to the manager that this is no longer an issue or is no longer a problem; or alternatively, hinting to the manager that this problem or topic or client is no longer receiving the adequate level of attention from organizational team-members). In some embodiments, the system may generate a “trending score” for each such topic/client/insight; and enables the manager to configure that it would receive an immediate alert/notification, only if the Trending Score changes by at least N percent or by at least M percent points, or if a topic/client/insight was newly added or conversely was removed or became non-important. In some embodiments, the manager may define that such alerts or notifications would be sent only in accordance with additional filtering criteria that the manager can define; for example, “only those related to Europe, or derived from European meetings”, or “only those that are related to Budget/Profit/Revenue/Expenses, and not to Marketing/Sales/Legal”; or other filtering criteria.

In some embodiments, each insight that is derived or generated by the LLM engine, from the plurality of meeting transcripts that it reviews as input, may optionally be accompanied by proof/evidence/quoted text/excerpts, and/or may be accompanied by “text snippets” and/or “audio snippets” and/or “video snippets” that correspond/support/demonstrate each such insight generated by the LLM engine. For example, the LLM engine may generate an output indicating to the manager, “Based on LLM analysis of 6,000 meeting transcripts from the past 14 days, the topic of Sales in France is of great importance/relevance to the organization”; and the LLM engine or the associated system may provide textual snippets from selected meeting transcript that demonstrate/prove/support that insight; and/or may provide links or shortcuts or other GUI elements that enable the manager to directly access the relevant audio segments/video clips that demonstrate/prove/support that insight.

In some embodiments, one or more features may be privileged or may be associated with an Access Control mechanism; for example, enabling a system administrator to define, that the CEO is allowed to receive all LLM-generated insights/alerts and/or to access all corresponding meeting transcripts and/or their text snippets/audio segments/video clips; whereas, the Marketing Manager is allowed to receive only LLM-generated insights/alerts that are related to marketing/sales/advertising/public relations (or equivalent keywords/topics), and to access only their corresponding meeting transcripts and/or their particular portions of text snippets/audio segments/video clips; or that the CFO is not authorized to receive LLM-generated insights about marketing/sales, and is only authorized to receive LLM-generated insights about profit/revenue/expenses budget (or equivalent keywords/topics). Such rules may be defined and configured or modified from time to time, to ensure that each person or role in the organization has the adequate access privileges related to his/her field, and to prevent some employees or managers from spending time on analysis of topics that are not directly related to their defined roles in the organization.

The terms “meeting” or “discussion” as used herein may include, for example, a face-to-face meeting that is captured by audio recording and/or video recording, a telephonic meeting or discussion, a recorded discussion, a telephone conference call, a video meeting, a video conference call, a hybrid or mixed meeting in which one or more users participate in person and/or one or more other users participate via telephone and/or one or more other users participate via video conferencing and/or one or more other users participate via other means (e.g., via a messaging application or a chat application), a virtual meeting or a remote meeting held via a platform such as Zoom or Microsoft Teams or Google Meet, or the like.

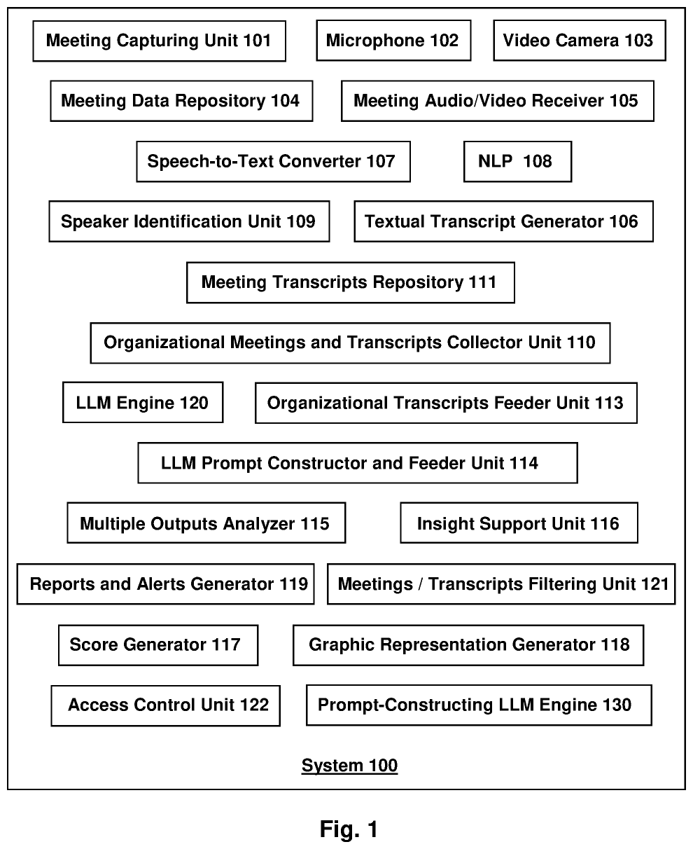

Reference is made to FIG. 1, which is a schematic block diagram illustration of a system 100, in accordance with some demonstrative embodiments of the present invention.

System 100 may comprise a Meeting Capturing Unit 101, able to capture and/or record and/or acquire audio and/or video and/or audio-video of a meeting. For example, an acoustic microphone 102 may capture audio of a meeting; and optionally, a video camera 103 or imager may capture video or audio-and-video of a meeting or an audio conferencing or video conferencing. The captured audio/video data may be stored in a Meeting Data Repository 104; which may optionally also store data or meta-data about the meeting itself and/or about its participants. For example, the Meeting Data Repository 104 may store data indicating the names and the organizational roles of each meeting participant (e.g., “John Smith, CEO” and “Jane Brown, CFO”), which may be extracted or obtained from the screen-names or usernames of meeting participants, and/or from analysis of email messages or calendar invitations that were exchanged to schedule the meeting and that contain such information, and/or from other data sources (e.g., from an organizational chart or organizational director that may be stored for the entire organization or for departments thereof).

Additionally or alternatively, such audio and/or video of a meeting may be received from an external source, such as, from a tele-conferencing service that is operated by a third party; for example, a Meeting Audio/Video Receiver 105 may receive audio/video of such meeting from the external source or from the third-party, and may store it (in its original format, or after being reformatted or encoded or processed) in the Meeting Data Repository 104.

A speech-to-text converter 107 may process the audio of a meeting, and may generate a textual transcript of the discussions held in the meeting. Optionally, a Natural Language Processing (NLP) unit 108 may perform initial analysis or the transcript, in order to improve it and/or to fine-tune it or to remove ambiguities or to make corrections and/or detect the intent in a phrase. For example, participant Adam said during the meeting “we need two computers for this project”; the speech-to-text converter 107 may initially transcribe this phrase as “we need to cars for this project”; and the NLP unit 108 may then fine-tune and correct this transcription to become “we need two cars for this project” based on an NLP analysis that detects the plural form “computers” after the word “two”, and that selects it to be “two” rather than “to” or “too”.

Optionally, a speaker identification unit 109 may further analyze the audio/video data, and/or the generated transcript, and/or other meta-data; and may identify that a particular participant has spoken at particular time-slots; and may tag or mark his utterances or his audio-portions as belonging to him. In some embodiments, the speaker identification may be based on contextual analysis of content; for example, if Participant A said “I often ask myself, James, how can we fix this problem?”, then the speaker identification unit 109 may determine that Participant A is James. Similarly, if Participant B said “What do you, Bob, think about this?”, and then Participant C says “Well, Rachel, this is a great question”, then the speaker identification unit 109 may determine that Participant B is Rachel and that Participant Cis Bob. In another example, the audio recording of the meeting may be correlated with data from a scheduling application or a calendar application or a meeting invitation exchange, in order to obtain data or meta-data that can be used for speaker identification; for example, the calendar entry or the meeting invitation may show a meeting that took place from 11:00 AM to 11:45 AM, with participants “Rachel, Bob, James”; the speaker identification unit 109 may identify a female voice based on a higher frequency or higher pitch of utterances, or based on contextual analysis (e.g., a participant responds with “I think she is right in what she just said”), thereby determining that a particular participant is female, and correlating this determination with calendar/scheduling/meeting invitation data in order to deduce that this female participant is Rachel. The speaker identification unit 109 may augment or modify the transcript of the meeting, by adding to it the actual names of participants; or, at least, by adding to the transcript generic place-holders such as “Participant A” and “Participant B” and “Participant C” if they real names cannot be deduced based on the current data. The capabilities and functionalities of the speaker identification unit 109 may then be used in order to construct a speaker-tailored prompt to the LLM Engine, or to construct a speaker-role/speaker-type prompt to the LLM Engine, which instructs the LLM Engine to generate insights only from the transcript-portions that were uttered/spoken/provided by a particular speaker/speaker-role/speaker-type, rather than from All the transcript of All the participants in meeting(s). For example, the LLM prompt may be, “Please generate insights from the 500 meeting transcripts of last week, but only from what Salespersons of the organization said, and not from what Customers/Clients of the organization said”; or conversely, “Please generate insights from the 600 meeting transcripts of last week, but only from what Customers/Clients of the organization said, and not from what Salespersons of the organization said”; or, “Please generate insights from the 400 meeting transcripts of last week, but only from what Accounting Department team-members said, and not from what other organizational roles said”; or, “Please generate insights from the 600 meeting transcripts of last month, but only from what Marketing Department team-members said, and not from what other organizational roles said”; or, “Please generate insights from the 400 meeting transcripts of last week, but only from what non-team-members said (e.g., any person who is Not identified as an employee of the organization), and not from what team-members said”; or, “Please generate insights from the 550 meeting transcripts of last month, but only from what External Consultants to the organization said, and not from what any other participant/s said”; or, “Please generate insights from the 720 meeting transcripts of last week, but only from what was said by any participant whose role is at least Vice President or higher”; and so forth, using other and/or additional conditions or filtering criteria.

A Textual Transcript Generator 106 may operate to generate a textual transcript for each meeting held in or by the organization, or for each meeting in which an employee or team-member of the organization has participated. In some embodiments, this may be performed using the speech-to-text converter 107, and/or using the NLP unit 108, and/or using the speaker identification unit, to thus provide a textual transcript that also indicates the relevant speakers and optionally also their organizational roles. In some embodiments, one or more textual transcript may be readily obtained from other sources; for example, from a transcription service or a meeting transcribing service, or from an already-transcribed audio clip/video clip that one of the participants has recorded or provided or uploaded. In some embodiments, optionally taking into account relevant laws regarding audio/video recordings, consent can be obtained from the relevant participant(s) prior to recording and/or transcribing the meeting. Transcripts of all organizational meetings may be stored in central Meeting Transcripts Repository 111, together with meta-data indicating the time-and-place of each meeting, the duration, the participant names and organizational roles, the meeting topic(s) or agenda, or the like.

An Organizational Meetings and Transcripts Collector Unit 110 operates on a continuous basis, or daily or nightly or weekly, to search and/or find and/or identify and/or collect all the recordings of all the meetings that took place within a particular time-period (e.g., yesterday; this week; last week; this month; or the like), and further operates to obtain and collect the textual transcripts of all such meetings. For example, the Organizational Meetings and Transcripts Collector Unit 110 may scan or search all the calendars/schedule representations of all the team-members of the organization, may identify and extract data about meetings, and may then obtain the relevant recording and/or transcript from the Meeting Data Repository 104 and/or the Meeting Transcripts Repository 111.

System 100 further comprises a Large Language Model (LLM) engine 120, capable of parsing or analyzing a large text that is provided to it as input, or a plurality of such texts that are provided to it as input; and further capable to perform LLM-based analysis to transform or encode the inputs into a textual output, based on a textual prompt that is provided to it.

The LLM engine 120 may be pre-trained to extract or derive or deduce business-related insights, by utilizing a training set of numerous transcripts of business meetings; optionally provided with pre-labeled parameters or classifications or example insights. For example, the training set may include a meeting transcript, having the sentence “we have a big problem with the produce sales in France”, associated with manually-created labels of “problem” and “France”; and may include the sentence “we are about to go over the marketing budget in Japan”, associated with the labels “problem” and “Japan” and “budget” and “marketing”. The training set may further provide to the LLM engine parameters to indicate business relevance or business importance of particular features or topics or keywords; for example, indicating that the phrase “legal problem” in a meeting transcript has a business importance score of 90 (out of 100), and the phrase “marketing campaign” has a business importance score of 72, and the phrase “we can try this” has a business importance score of 34, or the like.

An Organizational Transcripts Feeder Unit 113 operates to feed or to send or to enter as input, in to the LLM engine 120, the organizational textual transcripts that were collected automatically by the Organizational Meetings and Transcripts Collector Unit 110 for a time-period T (e.g., one day, one week, two weeks, one month). For example, in some embodiments, the Transcripts Feeder Unit 113 may operate nightly, such as at 1 AM every night; may obtain all the transcripts of all the organizational meetings that took place in the preceding day; and may feed all these transcripts into the LLM engine. In other embodiments, for example, the Transcripts Feeder Unit 113 may operate weekly, such as on Monday at 2 AM, and may feed into the LLM engine 120 all the transcripts of all the organizational meetings that took place in the preceding week that has just ended. Similarly, the Transcripts Feeder Unit 113 may operate bi-weekly or monthly, and may feed into the LLM engine 120 all the transcripts of all the organizational meetings that took place in the preceding 14 or 30 days, respectively. Additionally or alternatively, the Transcripts Feeder Unit 113 may be triggered or launched in response to a user command (e.g., a manager command), instructing it to feed right now to the LLM engine 120 the transcripts of all meetings from the past H hours or from the last D days. In other embodiments, additionally or alternatively, the Transcripts Feeder Unit 113 may operate on a continuous or generally continuous basis, and may continuously feed into the LLM engine 120 each and every transcript of every organizational meeting, within seconds or within minutes of the ending of each such meeting and/or from the completion of transcription of each meeting. In some embodiments, the Transcripts Feeder Unit 113 may even operate on a continuous and real time basis, and may continuously feed into the LLM engine 120 every word or every phrase or every utterance that is said in every organizational meeting, immediately upon its utterance, and while each meeting is still ongoing; and may input each such sentence into a suitable “bin” of the entire input corpus that is provided to the LLM engine; for example, adding Sentence 17 to the ongoing transcript of Meeting number 1, and in parallel (or immediately thereafter) adding Sentence 26 to the ongoing transcript of Meeting number 5 which is taking place in parallel, and in parallel (or immediately thereafter) adding Sentence 278 to the ongoing transcript of Meeting number 1, and so forth; such that the LLM engine has, at any given moment, an up-to-date and near-real-time accumulation of both the completed transcript and the partial transcripts of still-ongoing meetings; and this may even allow the LLM engine 120 to generate real time or near-real-time business insights, as well as managerial alerts and notification messages, while such meeting(s) are still ongoing.

An LLM Prompt Constructor and Feeder Unit 114 operates to construct one or more prompts, and to feed them to the LLM engine 120. In some embodiments, the prompt may be selected from a pre-defined list of prompts. A demonstrative list of such LLM prompts that can be used in some embodiments may include, for example: (1) Please generate four business-related insights from the input transcripts; (2) Please generate three business-related insights that you as LLM engine regard as surprising or unexpected or counter-intuitive; (3) Please generate five business-related insights that you as LLM engine regard as related to high-importance problems that the organization should resolve; (4) Please generate four business-related insights that you as LLM engine regard as related to a deadline or target date that were missed or that are about to be missed; (5) Please generate four business-related insights that you as LLM engine regard as related to a budget that was breached or that is about to be breached; (6) Please generate three business-related insights that you as LLM engine regard as related to a legal problem that has occurred or that is likely to be encountered; (7) Please generate three business-related insights that you as LLM engine regard as related to a reduction in the organization's profit or revenue; (8) Please generate three business-related insights that you as LLM engine regard as related to a possible increase in the organization's expenses; (9) Please generate three business-related insights that you as LLM engine regard as related to the most important client (or customer, or project, or product) of this organization; (10) Please generate three business-related insights that you as LLM engine regard as related to a marketing (or sales, or advertising, or public relations) problems (or achievements, or accomplishments); (11) Please generate three business-related insights that you as LLM engine regard as being crucial to the success or the efficient operation of this organization in the next 30 days (or in the next 90 days, or in the next 6 months); or the like.

In some embodiments, the LLM Prompt Constructor and Feeder Unit 114 may operate by utilizing a pre-defined set of rules or prompts or prompt-segments or prompt-portions, that the LLM Prompt Constructor and Feeder Unit 114 may select and/or may concatenate (e.g., as strings) to construct the final LLM Prompt. In some embodiments, a pre-defined set of prompts may be provided as a Prompts Pool or a Prompts Bank; and the LLM Prompt Constructor and Feeder Unit 114 selects therefrom one LLM prompt to apply, or several (or numerous) LLM prompts to apply separately one-by-one; based on one or more selection rules which may be based on user inputs. For example, a first end-user may indicate that he wants “all business insights” that can be deduced by the LLM Engine from all the organizational meetings in the past 14 days; and a second end-user may indicate that she wants “only marketing-related insights” that can be deduced by the LLM Engine from only the organizational meetings that included at least one participant from the European branches of the organization and that included the typic of “Advertising” in their meeting agenda. The LLM Prompt Constructor and Feeder Unit 114 may construct the LLM prompt using a concatenation of prompt-segments, as strings.

For example, a User Interface (UI) or a Graphical User Interface (GUI), with fields and drop-down menus, may be generated by the system and may be displayed to the end-user (e.g., CEO, CFO, manager) on a screen of his laptop or smartphone; enabling the end-user to select: (A) How many insights do you want to be generated? Select from 3 or 5 or 10; and then, (B) From organizational meetings of which time period? Select from: organizational meetings that took place today, or yesterday, or this week, or last week, or this month; and then, (C) From which geographical region? Select from: from the entire organization worldwide, or from only the European branches, or from only the Japanese branch; and then, (D) do you want to add a particular filtering condition? Select from, No filtering condition, or “only insights from what Customers said in meetings and not team-members”, or “only insights from what External Consultants said in meetings”, or “only insights from what Vendors/Suppliers said in meetings”; and then, (E) do you want to add a particular keyword or name or topic-of-interest such that only for that keyword/s or topic-of-interest the insights would be generated? Select from No keywords/No topic-of-interest, or “Topic=Budget”, or “Topic=Legal”, or “Topic-Marketing”, or Keyword that is free-style text that the end-user can type and provide (e.g., keyword “Microsoft”, or keyword “Promotion”, or keyword “Public Relations”, or keyword “Recurring Problem”). The LLM Prompt Constructor and Feeder Unit 114 then constructs the LLM prompt accordingly, based on selection of strings (that correspond to the user's selections) and concatenation of such strings (prompt-segments) into a final LLM prompt. In other embodiments, the LLM Prompt Constructor and Feeder Unit 114 selects—even randomly or pseudo-randomly—a general LLM prompt from a set of 10 or 50 pre-defined LLM prompts, such as those that were demonstrated above; in order to provide to the LLM Engine the full capability to generate any type of business insights, from any geographical region and in any topic that the LLM Engine by itself would autonomously decide to be noteworthy or business-related or otherwise have business significance or importance.

In some embodiments, optionally, the LLM Prompt Constructor and Feeder Unit 114 may be—by itself—an AI engine that constructs prompts (to the LLM engine 120) based on AI/DL/ML/RL/NN analysis that takes into account business-related parameters that are tailored to the specific organization. For example, the LLM Prompt Constructor and Feeder Unit 114 may construct a first type of prompts for a first type of organization (e.g., a company that makes and sells plastic toys), and may construct a second, different, type of prompts for a second type of organization (e.g., a bank or a brokerage firm); for example, the LLM Prompt Constructor and Feeder Unit 114 may utilize or may construct a prompt that involves “product liability” for the toy company (and not for the bank), and may utilize or construct a prompt that involves “cryptocurrency” or “options trading” for the bank (and not for the toy company).

In some embodiments, a single prompt is fed to the LLM engine 120, with regard to the input transcripts of meetings; and a single output is generated by the LLM engine. In other embodiments, this may be followed by the same prompt but in a slightly modified manner, such as “Please generate two more business insights”, or “Please generate two more business insights that focus on other operational aspects of the organization”. In some embodiments, optionally, two or more different prompts, or even all the prompts from the prompts list, may be fed sequentially to the LLM engine, to generate a plurality of outputs; for example, each of the 11 demonstrative prompts listed above may be fed, separately and automatically, to the LLM engine 120 with regard to the same input transcripts; and accordingly, the LLM engine 120 generates 11 sets of business insights; and optionally, a Multiple Outputs Analyzer 115 may then prioritize or filter-out or sort those business insights based on pre-defined rules. In some embodiments, for example, pre-defined prioritization rules may indicate that “legal-related” insights have priority over “finance-related” insights, which in turn have priority over “personnel-related” insights, which in turn have priority over “advertising-related insights”. In other embodiments, the LLM engine 120 may be requested, in each of the original prompts that was fed to it, to also generate a Business Importance Score, such as on a scale of 0 to 100, to indicate the level of Business Importance that the LLM engine allocates to each such insight. In other embodiments, for example, each of the 11 sets of insights includes 3 insight, such that a total of 33 insights were generated from 11 prompts; and a meta-analysis LLM query may be performed, such that those 33 insights are fed into the LLM engine 120, with a prompt of “Please select the five insights, from these 33 insights, that you as LLM engine regard as the most crucial to the success of the organization”. Other mechanisms may be used to allocate priority/importance/relevance scores to each LLM-generated business insight, and/or in order to select the “top five” or the “top N” insights out of a plurality of insights that were generated by the LLM engine.

An Insight Support Unit 116 operates to find and/or store one or more transcript portions (as a text snippet and/or audio segment and/or video clip) that can provide support/proof/evidence to each particular business insight that the LLM engine generated; and to enable the user to access such supporting data-item. For example, each original prompt may further command the LLM engine, “Please point to at least three places in multiple transcript that support each business insight that you generate”, or “Please point to all the places in all the transcripts that support each business insights that you generate”; and the Insight Support Unit 116 may store such pointers or indicators, and may enable a user to view or access those data-items upon request. For example, a manager may review the LLM-generated insight of “There is a problem with Sales in France”; may request to access the supporting data; and may be provided with audio/video segments in which meeting participants, in a particular meeting or across multiple meetings, describe or discuss problem(s) in the sales in France.

A Reports and Alerts Generator 119 operates to generate and/or send reports and/or alerts and/or notifications, to one or more pre-defined recipients, with regard to LLM-generated business insights. For example, every morning at 6 AM, the system automatically commands the LLM engine 120 to parse and to analyze all the textual transcripts of all the meetings that took place on the preceding day; and to generate from them ten business-related insights; and to order them according to their importance to the organization's success (as estimated by the LLM engine) and/or based on other criteria; and the Reports and Alerts Generator automatically sends that ordered list of business insights, derived automatically from hundreds of yesterday's meetings, to the email address of the CEO and/or to the Instant Messaging (IM) application of the CFO, or the like. Similarly, a weekly list of LLM-generated business-related insights, generated by the LLM engine from 5,000 meeting transcripts of the past week, can be automatically generated by the LLM engine every Sunday morning, and can be similarly sent or provided to particular managers or users.

Additionally or alternatively, an Immediate Alert may be sent to one or more recipients (e.g., the CEO, the CFO, the legal counsel) if a particular type of LLM-generated business insight is deduced by the LLM engine 120; based on one or more pre-defined rules, or even based on LLM-based discretion/analysis by the LLM-engine 120 itself. In some embodiments, for example, the system may be configured such that any LLM-generated business insight is automatically sent to the CEO of the organization, as part of an ongoing Feed of incoming business insights that the CEO can browse or read on his smartphone or computer, immediately as they are generated by the LLM engine based on analysis of input transcripts. In other embodiments, the system may be pre-configured such that any business-related insights that are related to “budget” or “profit” or “revenue” or “sales”, but not to “marketing” or “advertising”, would be automatically sent to the CFO (or, added to his continuous Feed of incoming business insights). In other embodiments, the LLM engine itself may be tasked with the decision of whether or not to send an immediate alert to a particular manager; for example, the LLM engine can be prompted with “Please generate today at 5 PM exactly three business-related insights from all the meeting transcripts of all the meetings that took place today by that time; and then, if you as LLM engine regard any of those three insight to be of crucial importance to the organization's success, then add the phrase ‘Crucially Urgent’ to that insight”; and the Reports and Alerts Generator may be configured to check each LLM-generated insight, and if it contains the phrase ‘Crucially Urgent’ then the Reports and Alerts Generator sends it immediately to the CEO and/or to other pre-designated managers or users, via SMS text/IM message/email message. Other criteria or conditions may be configured or defined or enforced for determining which LLM-generated insights to send, to which recipients, at what frequency, whether or not to send them immediately upon generation, whether or not to wait for accumulation of several insights or for a pre-defined time-point, or the like.

Some embodiments provide a computerized method comprising: (a) automatically obtaining or generating a plurality of organizational meeting transcripts, that correspond to a plurality of organizational meetings that took place within a particular time-period by participants that are associated with a particular organization; (b) automatically providing the plurality of organizational meeting transcripts as inputs to a Large Language Model (LLM) engine; (c) automatically providing to said LLM engine an LLM prompt, commanding the LLM engine to generate insights/business insights that the LLM engine can derive by performing LLM analysis of said plurality of organizational meeting transcripts; (d) automatically generating, by said LLM engine, based on said prompt and based on said plurality of textual transcripts, one or more LLM-generated insights/business insights. In some embodiments, steps (b) and (c) and (d) are performed autonomously by the LLM engine; wherein the LLM engine does not receive as input, or as part of said prompt, any guidance with regard to any topic-of-interest to which the LLM-generated insights/business insights should relate; wherein the LLM engine autonomously determines one or more topics-of-interest from an LLM-based analysis of said plurality of organizational meeting transcripts.

In some embodiments, the method comprises: generating by the LLM engine at least one LLM-generated insight/business insight that cannot be derived from analysis of a single organizational meeting transcript by itself, and that can only be derived from LLM-based analysis of two or more different organizational meeting transcripts taken in aggregate. For example, the textual transcript of Meeting 1 with Participants A and B and C may include the phrase “we have a great business loss in France”; the textual transcript of Meeting 2 with Participants D and E may include the phrase “our labor costs in Europe have tripled last month due to new regulatory requirements”; the textual transcript of Meeting 3 with Participants F and G may include the phrase “Our supplier in Paris has declared bankruptcy last week”; and the LLM engine may thus generated an LLM-based cross-meetings/cross-transcripts insight that indicates a “complex problem in the French unit of the organization due to increased labor costs and loss of a major supplier there”.

In some embodiments, the method comprises: generating by the LLM engine a list of N most-trending LLM-determined topics, derived from LLM-based analysis of said plurality of organizational meeting transcripts; wherein N is a pre-defined integer.

In some embodiments, the method comprises: generating by the LLM engine (or by a Score Generator 117 associated therewith) a Score, for each of said most-trending LLM-determined topics; wherein said Score indicates at least one of: (i) a Business Importance Score indicating level of business importance that the LLM-based analysis estimates for a particular LLM-determined topic; (ii) a Trending Score indicating a level of trendiness of said topic within said plurality of organizational meeting transcripts, as estimated by the LLM-based analysis.

In some embodiments, the method comprises: at a Graphic Representation Generator unit 118, automatically generating a graphical representation of a plurality of scores for said plurality LLM-determined topics that were derived by the LLM-based analysis from the plurality of organizational meeting transcripts. The graphical representation may include at least one of: a heat map, in which LLM-determined topics are represented in different colors to indicate different scores; a bubble chart, in which LLM-determined topics are represented in different sizes to indicate different scores; a bar chart, in which LLM-determined topics are represented as different height bars to indicate different scores.

In some embodiments, the method comprises: automatically generating and sending an immediate notification alert, to one or more pre-defined recipients, to notify about a freshly-generated LLM-based insight/business insight; based on one or more pre-defined conditions that indicate which type of LLM-based insight/business insight should be sent as an immediate notification alert, and which other type of LLM-based insights/business insights should be aggregated towards a periodical log of accumulated LLM-based insights/business insights.

In some embodiments, the method comprises: automatically sending an immediate notification alert, to one or more pre-defined recipients, to notify about a freshly-generated LLM-based insight/business insight; based on an LLM-based determination that an immediate notification alert is required for a particular freshly-generated LLM-based insight/business insight.

In some embodiments, the method comprises: automatically sending an immediate notification alert, to one or more pre-defined recipients, to notify about a newly-identified change of trend in a previously-identified LLM-based insight/business insight.

In some embodiments, the method comprises: performing LLM-based analysis of only a partial subset of said plurality of organizational meeting transcripts that were generated for said particular time-period, based on one or more pre-defined filtering criteria that indicate one or more properties of organizational meetings that should be included in said partial subset for LLM-based analysis. For example, a Meetings/Transcripts Filtering Unit 121 may filter-out and/or filter-in, based on user inputs, meetings/transcript that meet particular user-defined criteria (topics, agenda, geographical region, roles of participants, number of participants, meeting length, or the like); such that the LLM-based analysis would be applied to only a partial group, or a subset, of all the meeting transcripts that were accumulated in the past day (or week, or month, or other pre-defined time-period), and not to all of those meeting transcripts.

In some embodiments, the method comprises: performing LLM-based analysis of only a partial subset of said plurality of organizational meeting transcripts that were generated for said particular time-period, based on one or more pre-defined filtering criteria that indicate, based on geographical region of one or more meeting participants, which organizational meeting transcripts to include in the LLM-based analysis and which other organizational meeting transcripts scripts to exclude from said LLM-based analysis.

In some embodiments, the method comprises: performing LLM-based analysis of only a partial subset of said plurality of organizational meeting transcripts that were generated for said particular time-period, based on one or more pre-defined filtering criteria that indicate, based on organizational roles of one or more meeting participants, which organizational meeting transcripts to include in the LLM-based analysis and which other organizational meeting transcripts to exclude from said LLM-based analysis.

In some embodiments, the method comprises: defining and enforcing an access control mechanism via an Access Control Unit 122, that selectively authorizes a first user to request LLM-generated insights/business insights from an LLM-based analysis of a first subset of organizational meeting transcripts; and that selectively authorizes a second user to request LLM-generated insights/business insights from an LLM-based analysis of a second, smaller, subset of organizational meeting transcripts.

In some embodiments, the method comprises: generating, for each LLM-generated insight/business insight, one or more supporting data-items selected from the group consisting of: (i) a text snippet from a particular organizational meeting transcript, (ii) an audio segment from an audio recording of a particular meeting, (iii) a video clip from a video recording of a particular meeting.

In some embodiments, the method comprises: automatically constructing said LLM prompt for the LLM engine, based on one or more user-provided keywords that indicate topics-of-interest that a user selected or provided. In some embodiments, the LLM engine is configured to generated LLM-generated that only pertain to the one or more user-provided keywords that indicate the topics-of-interest defined by the user. A user-provided keyword that indicates a topic-of-interest, as provided by the user and as then constructed to be part of the prompt to the LLM engine, can be one or more of, for example: a name of a person (e.g., “Jeff Bezos”); a name of an entity or organization or company or corporation (e.g., “Microsoft”); a name of a geographical place or venue or region (e.g., “Japan”, or “Europe”, or “Boston”); a name of a time-period or time-stamp or dime-indication (e.g., “Winter”, or “February”, or “Labor Day”); a name of a competitor; a name of a customer or client; a name of an event (e.g., “Elections”, or “Snowstorm”); a name of an organizational function or department (e.g., “Accounting” or “Marketing” or “Public Relations” or “Legal” or “Finance”); a keyword that is typically associated with a particular organizational function or department (e.g., “Budget”, or “Advertising”, or “Promotion”, or “Contract”, or “Customer Acquisition”); a keyword that indicates an organizational role or a group of organizational roles (e.g., “CEO”, or “CFO”, or “Vice President”, or “Salesperson”, or “Project Managers”, or “Consultant”, or “External Consultant”, or “Vendor”, or “Supplier”); a combination of keywords, optionally using Boolean operators or other operators (e.g., “CFO and Budget”, or “CEO and Japan”, or “Microsoft and Advertising”); or the like.

In some embodiments, the method comprises: constructing said LLM prompt to specifically command the LLM engine to generate, from said plurality of organizational meeting transcripts, LLM-generated insights/business insights that the LLM engine considers to be surprising or unexpected or counter-intuitive. For example, the LLM Prompt Constructor and Feeder Unit 114 may select and/or construct and/or provide to the LLM engine an LLM prompt such as, “Please generate, from the textual transcripts of all the organizational meetings that took place in the past 7 days, any insights or business insights that you as LLM Engine consider to be surprising or unexpected or counter-intuitive”.

In some embodiments, the method comprises: constructing said LLM prompt to specifically command the LLM engine to generate, from said plurality of organizational meeting transcripts, LLM-generated insights/business insights that the LLM engine considers to indicate a problem that the organization needs to resolve. For example, the LLM Prompt Constructor and Feeder Unit 114 may select and/or construct and/or provide to the LLM engine an LLM prompt such as, “Please generate, from the textual transcripts of all the organizational meetings that took place in the past 14 days, any insights or business insights that you as LLM Engine consider to indicate a particular problem that the organization is facing and that needs to be resolved”.

In some embodiments, the method comprises: constructing said LLM prompt to specifically command the LLM engine to generate, from said plurality of organizational meeting transcripts, LLM-generated insights/business insights that the LLM engine considers to indicate a surprising achievement (or failure) or an unexpected accomplishment (or failure). For example, the LLM Prompt Constructor and Feeder Unit 114 may select and/or construct and/or provide to the LLM engine an LLM prompt such as, “Please generate, from the textual transcripts of all the organizational meetings that took place in the past 10 days, any insights or business insights that you as LLM Engine consider to indicate a surprising achievement (or failure) or an unexpected accomplishment (or failure)”.

In some embodiments, the method comprises: constructing said LLM prompt to specifically command the LLM engine to generate, from said plurality of organizational meeting transcripts, LLM-generated insights/business insights that the LLM engine considers to indicate a recurring problem across multiple different groups within the organization. For example, the LLM Prompt Constructor and Feeder Unit 114 may select and/or construct and/or provide to the LLM engine an LLM prompt such as, “Please generate, from the textual transcripts of all the organizational meetings that took place in the past 30 days and only in Europe, any insights or business insights that you as LLM Engine consider to indicate a recurring problem across multiple different groups within the organization”.

In some embodiments, the method comprises: separately feeding different LLM prompts, to said LLM engine, for operating on a same corpus of organizational meeting transcripts that were accumulated over said particular time period; and obtaining from the LLM engine a plurality (P) of LLM-generated insights/business insights that were generated in response to said different LLM prompts; feeding said plurality (P) of LLM-generated insights/business insights, back into said LLM engine, together with a new LLM prompt that commands the LLM engine to select the M insights/business insights that the LLM engine considers to be of greatest business importance; and obtaining from said LLM engine the M insights/business insights that the LLM engine considers to be of greatest business importance out of said plurality (P) of LLM-generated insights/business insights.

In some embodiments, the method comprises: constructing said LLM prompt by utilizing a prompt-constructing LLM engine 130 that is trained on a training dataset that is tailored to a particular industry to which said organization belongs (e.g., “Retail” or “Banking” or “Telecommunications”), or to a particular field or industry or product or service that is associated with the organization (e.g., “Electric Vehicles” or “Laptop Computers” or “Wood Furniture” or “Cleaning Services”). In some embodiments, such list or keyword(s) may be pre-programmed by a system administrator that installs or deploys the system for a particular organization, or may be hardcoded, or may be obtained from a pre-defined topology/dataset that indicates keywords that are typically associated with a particular word or name or organization.

In some embodiments, the method comprises: performing LLM-based analysis in which the LLM engine is commanded to generate insights based only on transcript-portions that correspond to utterances by a particular speaker-name (e.g., “John Smith”) or speaker-role (e.g., “CFO”, or “Project Manager”) or speaker-type (e.g., “Vendor”, or “Customer”, or “Consultant”, or “Employee”), and not by all meeting participants.

In some embodiments, the method comprises: performing LLM-based analysis in which the LLM engine is commanded to generate insights based only on transcript-portions that correspond to utterances by customers (or clients; or vendors; or suppliers) of the organization and not by team-members of the organization.

In some embodiments, the method comprises: performing LLM-based analysis in which the LLM engine is commanded to generate insights based only on transcript-portions that correspond to utterances by external consultants (e.g., external legal counsel; external accountant external Public Relations firm) to the organization, and not by team-members (or employees, or payroll employees) of the organization.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

The present invention may be implemented by using hardware units, software units, processors, CPUs, DSPs, integrated circuits, memory units, storage units, wireless communication modems or transmitters or receivers or transceivers, cellular transceivers, a power source, input units, output units, Operating System (OS), drivers, applications, and/or other suitable components.

The present invention may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

The present invention may be implemented by using code or program code or machine-readable instructions or machine-readable code, which is stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such device to perform a method in accordance with the present invention.

Embodiments of the present invention may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, an Augmented Reality (AR) device or headset or gear, a Virtual Reality (VR) device or headset or gear, a “kiosk” type device, a vending machine, an Automatic Teller Machine (ATM), a laptop computer, a desktop computer, a vehicular computer, a vehicular dashboard, a vehicular touch-screen, or the like.

The system(s) and/or device(s) of the present invention may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of the present invention may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with embodiments of the present invention, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL. Ruby on Rails, Go, Cobol, Fortran, ActionScript, AJAX, XML, JSON, Lisp, Eiffel, Verilog, Hardware Description Language (HDL), BASIC, Visual BASIC, MATLAB, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results (e.g., within a pre-defined threshold level of similarity; such as, within 5 percent above or below a pre-defined threshold value), among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of the present invention have been illustrated and described herein, many modifications, substitutions, changes, and equivalents may occur to those skilled in the art. Accordingly, the claims are intended to cover all such modifications, substitutions, changes, and equivalents.

What is claimed is:

1. A computerized method comprising:
(a) automatically obtaining or generating a plurality of organizational meeting transcripts, that correspond to a plurality of organizational meetings that took place within a particular time-period by participants that are associated with a particular organization;
(b) automatically providing the plurality of organizational meeting transcripts as inputs to a Large Language Model (LLM) engine;
(c) automatically providing to said LLM engine an LLM prompt, commanding the LLM engine to generate insights that the LLM engine can derive by performing LLM analysis of said plurality of organizational meeting transcripts;
(d) automatically generating, by said LLM engine, based on said prompt and based on said plurality of textual transcripts, one or more LLM-generated insights.

2. The computerized method of claim 1,
wherein steps (b) and (c) and (d) are performed autonomously by the LLM engine,
wherein the LLM engine does not receive as input, or as part of said prompt, any guidance with regard to any topic-of-interest to which the LLM-generated insights should relate;
wherein the LLM engine autonomously determines one or more topics-of-interest from an LLM-based analysis of said plurality of organizational meeting transcripts.

3. The computerized method of claim 1, comprising:
generating by the LLM engine at least one LLM-generated insight that cannot be derived from analysis of a single organizational meeting transcript by itself, and that can only be derived from LLM-based analysis of two or more different organizational meeting transcripts taken in aggregate.

4. The computerized method of claim 1, comprising:
generating by the LLM engine a list of N most-trending LLM-determined topics, derived from LLM-based analysis of said plurality of organizational meeting transcripts;
wherein N is a pre-defined integer.

5. The computerized method of claim 4, comprising:
generating by the LLM engine a Score, for each of said most-trending LLM-determined topics;
wherein said Score indicates at least one of:
(i) a Business Importance Score indicating level of business importance that the LLM-based analysis estimates for a particular LLM-determined topic;
(ii) a Trending Score indicating a level of trendiness of said topic within said plurality of organizational meeting transcripts, as estimated by the LLM-based analysis.

6. The computerized method of claim 5, comprising:
automatically generating a graphical representation of a plurality of scores for said plurality LLM-determined topics that were derived by the LLM-based analysis from the plurality of organizational meeting transcripts.

7. The computerized method of claim 6, wherein said graphical representation comprises at least one of:
a heat map, in which LLM-determined topics are represented in different colors to indicate different scores;
a bubble chart, in which LLM-determined topics are represented in different sizes to indicate different scores;
a bar chart, in which LLM-determined topics are represented as different height bars to indicate different scores.

8. The computerized method of claim 5, comprising:
automatically sending an immediate notification alert, to one or more pre-defined recipients, to notify about a freshly-generated LLM-based insight; based on one or more pre-defined conditions that indicate which type of LLM-based insight should be sent as an immediate notification alert, and which other type of LLM-based insights should be aggregated towards a periodical log of accumulated LLM-based insights.

9. The computerized method of claim 5, comprising:
automatically sending an immediate notification alert, to one or more pre-defined recipients, to notify about a freshly-generated LLM-based insight; based on an LLM-based determination that an immediate notification alert is required for a particular freshly-generated LLM-based insight.

10. The computerized method of claim 5, comprising:
automatically sending an immediate notification alert, to one or more pre-defined recipients, to notify about a newly-identified change of trend in a previously-identified LLM-based insight.

11. The computerized method of claim 1, comprising:
performing LLM-based analysis of only a partial subset of said plurality of organizational meeting transcripts that were generated for said particular time-period, based on one or more pre-defined filtering criteria that indicate one or more properties of organizational meetings that should be included in said partial subset for LLM-based analysis.

12. The computerized method of claim 1, comprising:
performing LLM-based analysis of only a partial subset of said plurality of organizational meeting transcripts that were generated for said particular time-period, based on one or more pre-defined filtering criteria that indicate, based on geographical region of one or more meeting participants, which organizational meeting transcripts to include in the LLM-based analysis and which other organizational meeting transcripts scripts to exclude from said LLM-based analysis.

13. The computerized method of claim 1, comprising:
performing LLM-based analysis of only a partial subset of said plurality of organizational meeting transcripts that were generated for said particular time-period, based on one or more pre-defined filtering criteria that indicate, based on organizational roles of one or more meeting participants, which organizational meeting transcripts to include in the LLM-based analysis and which other organizational meeting transcripts to exclude from said LLM-based analysis.

14. The computerized method of claim 1, comprising:
defining and enforcing an access control mechanism,
that selectively authorizes a first user to request LLM-generated insights from an LLM-based analysis of a first subset of organizational meeting transcripts,
and that selectively authorizes a second user to request LLM-generated insights from an LLM-based analysis of a second, smaller, subset of organizational meeting transcripts.

15. The computerized method of claim 1, comprising:
generating, for each LLM-generated insight, one or more supporting data-items selected from the group consisting of:
(i) a text snippet from a particular organizational meeting transcript,
(ii) an audio segment from an audio recording of a particular meeting,
(iii) a video clip from a video recording of a particular meeting.

16. The computerized method of claim 1, comprising:
automatically constructing said LLM prompt for the LLM engine, based on one or more user-provided keywords that indicate topics-of-interest that a user selected or provided;
wherein the LLM engine is configured to generated LLM-generated that only pertain to the one or more user-provided keywords that indicate the topics-of-interest defined by the user.

17. The computerized method of claim 1, comprising:
constructing said LLM prompt to specifically command the LLM engine to generate, from said plurality of organizational meeting transcripts, LLM-generated insights that the LLM engine considers to be surprising or unexpected or counter-intuitive.

18. The computerized method of claim 1, comprising:
constructing said LLM prompt to specifically command the LLM engine to generate, from said plurality of organizational meeting transcripts, LLM-generated insights that the LLM engine considers to indicate a problem that the organization needs to resolve.

19. The computerized method of claim 1, comprising:
constructing said LLM prompt to specifically command the LLM engine to generate, from said plurality of organizational meeting transcripts, LLM-generated insights that the LLM engine considers to indicate a surprising achievement or an unexpected accomplishment.

20. The computerized method of claim 1, comprising:
constructing said LLM prompt to specifically command the LLM engine to generate, from said plurality of organizational meeting transcripts, LLM-generated insights that the LLM engine considers to indicate a recurring problem across multiple different groups within the organization.

21. The computerized method of claim 1, comprising:
separately feeding different LLM prompts, to said LLM engine, for operating on a same corpus of organizational meeting transcripts that were accumulated over said particular time period; and obtaining from the LLM engine a plurality (P) of LLM-generated insights that were generated in response to said different LLM prompts;
feeding said plurality (P) of LLM-generated insights, back into said LLM engine, together with a new LLM prompt that commands the LLM engine to select M of the LLM-generated insights that the LLM engine considers to be of greatest business importance; and obtaining from said LLM engine said M LLM-generated insights that the LLM engine considers to be of greatest business importance out of said plurality (P) of LLM-generated insights.

22. The computerized method of claim 1, comprising:
constructing said LLM prompt by utilizing a prompt-constructing LLM engine that is trained on a training dataset that is tailored to a particular industry to which said organization belongs.

23. The computerized method of claim 1, comprising:
performing LLM-based analysis in which the LLM engine is commanded to generate insights based only on transcript-portions that correspond to utterances by a particular speaker-name or speaker-role or speaker-type, and not by all meeting participants.

24. The computerized method of claim 1, comprising:
performing LLM-based analysis in which the LLM engine is commanded to generate insights based only on transcript-portions that correspond to utterances by customers of the organization and not by team-members of the organization.

25. The computerized method of claim 1, comprising:
performing LLM-based analysis in which the LLM engine is commanded to generate insights based only on transcript-portions that correspond to utterances by external consultants to the organization and not by team-members of the organization.

26. A non-transitory storage medium having stored thereon instructions that, when executed by a machine, cause the machine to perform a method comprising:
(a) automatically obtaining or generating a plurality of organizational meeting transcripts, that correspond to a plurality of organizational meetings that took place within a particular time-period by participants that are associated with a particular organization;
(b) automatically providing the plurality of organizational meeting transcripts as inputs to a Large Language Model (LLM) engine;
(c) automatically providing to said LLM engine an LLM prompt, commanding the LLM engine to generate insights that the LLM engine can derive by performing LLM analysis of said plurality of organizational meeting transcripts;
(d) automatically generating, by said LLM engine, based on said prompt and based on said plurality of textual transcripts, one or more LLM-generated insights.

27. A system comprising:
one or more hardware processors, configured to execute code;
associated with one or more memory units, configured to store data;
wherein the one or more hardware processors are configured to perform an automated process comprising:
(a) automatically obtaining or generating a plurality of organizational meeting transcripts, that correspond to a plurality of organizational meetings that took place within a particular time-period by participants that are associated with a particular organization;
(b) automatically providing the plurality of organizational meeting transcripts as inputs to a Large Language Model (LLM) engine;
(c) automatically providing to said LLM engine an LLM prompt, commanding the LLM engine to generate insights that the LLM engine can derive by performing LLM analysis of said plurality of organizational meeting transcripts;
(d) automatically generating, by said LLM engine, based on said prompt and based on said plurality of textual transcripts, one or more LLM-generated insights.
